(19) United States
(12) Patent Application Publication
(10) Pub. No.: US 2021/0142404 A1
(43) Pub. Date: May 13, 2021

(54) APPARATUS AND METHOD FOR PROVIDING CREDIT ASSESSMENT INFORMATION, FINANCIAL PRODUCT RECOMMENDATION APPARATUS AND CONSULTATION APPARATUS INCLUDING SAME

(71) Applicant: F&U Credit Information Co., Ltd., Seoul (KR)

(72) Inventors: Woong Ki KIM, Seoul (KR); Myung Ki CHUNG, Seoul (KR); Tae Sup LEE, Seoul (KR); Do Myung HYUN, Seoul (KR); Duck Ju YUN, Seoul (KR); Myungsuk RYU, Seoul (KR); Yong Wook JANG, Seoul (KR)

(21) Appl. No.: 17/087,380

(22) Filed: Nov. 2, 2020

(30) Foreign Application Priority Data
Nov. 11, 2019 (KR) 10-2019-0143270

(51) Int. Cl. G06Q 40/02; G06Q 20/10

(52) U.S. Cl. CPC G06Q 40/025; G06Q 20/102

(57) ABSTRACT

An apparatus for providing credit assessment information includes an information collection unit collecting communication information of a user having a record of communication bill non-payments, a first assessment unit assessing whether the user falls within a delinquent type using first assessment factors and a second assessment unit assessing whether to fall within a user type of a high probability of voluntary payment using second assessment factors. The apparatus also includes a third assessment unit assessing whether to fall within a type of user who has resolved the communication bill non-payments in a short period of time using third assessment factors, a fourth assessment unit assessing whether an attitude of the user falls within a positive attitude or a negative attitude using fourth assessment factors and a credit rating assessment unit assessing a credit rating of the user based on the non-payment type assessment model.

### CROSS-REFERENCE TO RELATED APPLICATION

This application claims priority to Korean Patent Application No. 10-2019-0143270, filed on Nov. 11, 2019, the entire contents of which are incorporated herein by reference.

### BACKGROUND

### Technical Field

The present disclosure relates to an apparatus for providing credit assessment information for providing a credit rating through data analysis of a user who has a record of non-payments.

### Description of Related Technology

With the development of mobile communication technology, mobile communication terminals for using mobile communication services have been widely used. Accordingly, the application areas of mobile communication terminals are increasing.

Mobile communication terminals provide not only communication but also important functions for conducting various kinds of daily life such as financial transactions, means of living, collection of information on daily living, business means, and so on.

People pay monthly fees for mobile terminals based on the usage of such mobile communication terminals, and financial companies use the payment status of mobile terminals as one of the indies of credit rating.

### SUMMARY

In order to resolve the problems above, it is an object of the present disclosure to assess appropriate credit ratings for users who have a record of non-payments through big data analysis on the users having a record of non-payments, and to provide financial products accordingly.

In accordance with a first aspect of the present disclosure, there is provided an apparatus for providing credit assessment information comprising: an information collection unit configured to collect communication information of a user who has a record of communication non-payments (or communication bill non-payments); a first assessment unit configured to generate first assessment factors using the communication information, and to assess whether the user falls within a delinquent type using the first assessment factors; a second assessment unit configured to generate second assessment factors using the communication information, and to assess whether to fall within a user type of a high probability of voluntary payment using the second assessment factors; a third assessment unit configured to generate third assessment factors using the communication information, and to assess whether to fall within a type of user who has resolved the communication non-payments in a short period of time using the third assessment factors; a fourth assessment unit configured to generate fourth assessment factors using the communication information, and to assess whether an attitude of the user falls within a positive attitude or a negative attitude using the fourth assessment factors; and a credit rating assessment unit configured to generate a non-payment type assessment model or the user using the first assessment factors to fourth assessment factors, and to assess a credit rating or the user based on the non-payment type assessment model, wherein the first assessment factors comprise the number of SIM card activations, the number of SIM card device replacements, the number of suspensions, the number of subscription lines, and an activation period, wherein the first assessment unit generates a first assessment index using the number of SIM card activations, the number of SIM card device replacements, the number of suspensions, the number of subscription lines, and the activation period, and wherein the first assessment index is used to assess whether the user falls within the delinquent type.

The first assessment unit may determine that the user falls within the delinquent type if the number of SIM card activations is greater than or equal to a predetermined number, the number of SIM card device replacements is greater than or equal to a predetermined number, the number of suspensions is greater than or equal to a predetermined number, the number of lines of new subscription or device replacement subscription is greater than or equal to a predetermined number, the activation period is within a predetermined range, or the activation period exceeds a predetermined range and an unpaid amount exceeds a predetermined amount.

The second assessment factors may comprise: an assessment factor 2-1 using a proportion of voluntary payment within the last one month out of the number of non-payments for the last 12 months, an average monthly usage amount, and subscription days; an assessment factor 2-2 using the number of non-payments for the last 12 months and the average monthly usage amount; an assessment factor 2-3 using the number of non-payments for the last 12 months and consultation for bill payments; an assessment factor 2-4 using a full payment cycle for the non-payments; and an assessment factor 2-5 using the number of non-payments for the last 12 months and information on SMS notification reception, wherein the second assessment unit generates a second assessment index using the assessment factor 2-1 to the assessment factor 2-5, and wherein the second assessment index is used to assess the user type of a high probability of voluntary payment.

The second assessment index may be determined by Equation 1 below,

s=r*1/nΣₙ₌₁^{∞}(aₙ) [Equation 1]

where r is a weight, n the number of the second assessment factors, and an is a score of each of the second assessment factors.

The third assessment factors may comprise: an assessment factor 3-1 using CE rating information, information on the number of non-payments, and sample information on a recovery rate of unpaid amounts; an assessment factor 3-2 using the CB rating information and payment method information; an assessment factor 3-3 using the CB rating information and information for each subscription per od; an assessment factor 3-4 including the CB rating information and presence or absence of an installment plan of a terminal; and an assessment factor 3-5 using the CB rating information and information on an amount of money other than a communication terminal, wherein the third assessment unit generates a third assessment index using the assessment factor 3-1 to the assessment factor 3-5, and the third assessment index is used to assess the type or user who has resolved the communication non-payments in a short period of time.

The third assessment index may be determined by Equation 2 below,

y=r*1/nΣₙ₌₁^{∞}(bₙ) [Equation 2]

where r is a weight, is the number of the third assessment factors, and bn is a score of each of the third assessment factors.

The fourth assessment factors may comprise: an assessment factor 4-1 including positive elements; an assessment factor 4-2 including negative elements; and an assessment factor 4-3 including risk elements, wherein the fourth assessment unit generates a fourth assessment index using the assessment factor 4-1 to the assessment factor 4-3, and the fourth assessment index is used to assess the positive attitude or the negative attitude of the user.

The assessment factor 4-1 may use information on a will to collect, payment methods, deadlines, date inquiries, changes in voice tone, and short talk time, for assessment, wherein the assessment factor 4-2 uses information on extensions of non-payments, inquiries on alternative methods, non-payment extensions, loss of contact, changes in voice tone, and long talk time, for assessment, and wherein the assessment factor 4-3 uses information on abusive language, swear words, slang, long talk time, and reports, for assessment.

The fourth assessment index may be determined by Equation 3 below,

p=r*1/nΣₙ₌₁^{∞}(cₙ) [Equation 3]

where r is a weight, n is the number of the fourth assessment factors, and Cn is a score of each of the fourth assessment factor.

The non-payment type model may be a model formed by summing up values of the second to fourth assessment indices assessed by the second to fourth assessment units based on the first assessment index assessed by the first assessment unit, and by classifying the credit rating the user into first to third grades based on the summed value.

In accordance with a second aspect of the present disclosure, there is provided a method for providing credit assessment information performed by an apparatus for providing credit assessment information, comprising: collecting communication information of a user who has a record of communication non-payments by an information collection unit of the apparatus for providing credit assessment information; generating first assessment factors using the communication information, and assessing whether the user falls within a delinquent type using the first assessment factors by a first assessment unit Of the apparatus for providing credit assessment information; generating second assessment factors using the communication information, and assessing whether to fall within a user type of a high probability of voluntary payment using the second assessment factors by a second assessment unit Of the apparatus for providing credit assessment information; generating third assessment factors using the communication information, and assessing whether to fall within a type of user who has resolved the communication non-payments in a short period of time using the third assessment factors by a third assessment unit Of the apparatus for providing credit assessment information; generating fourth assessment factors using the communication information, and assessing whether the user falls within a positive attitude or a negative attitude using the fourth assessment factors by a fourth assessment unit Of the apparatus for providing credit assessment information; and generating a non-payment type assessment model of the user using the first to fourth assessment factors, and assessing a credit rating based on the non-payment type assessment model by a credit rating assessment unit Of the apparatus for providing credit assessment information, wherein assessing whether the user falls within a delinquent type using the first assessment factors, wherein the first assessment factors comprise the number of SIM card activations, the number of SIM card device replacements, the number of suspensions, the number of subscription lines, and an activation period, wherein the first assessment unit generates a first assessment index using the number of SIM card activations, the number of SIM card device replacements, the number of suspensions, the number of subscription lines, and the activation period, and wherein the first assessment index is used to assess whether the user falls within the delinquent type.

In accordance with a third aspect of the present disclosure, there is provided a financial product recommendation apparatus comprising: an information collection unit configured to collect communication information of a user who has a record of communication non-payments; a first assessment unit configured to generate first assessment factors using the communication information, and to assess whether the use falls within a delinquent type using the first assessment factors; a second assessment unit configured to generate second assessment factors using the communication information, and to assess whether to fall within a user type of a high probability of voluntary payment using the second assessment factors; a third assessment unit configured to generate third assessment factors using the communication information, and to assess whether to fall within a type of user who has resolved the communication non-payments in a short period of time using the third assessment factors; a fourth assessment unit configured to generate fourth assessment factors using the communication information, and to assess whether an attitude of the user falls within a positive attitude or a negative attitude using the fourth assessment factors; a credit rating assessment unit configured to generate a non-payment type assessment model of the user using the first to fourth assessment factors, and to assess a credit rating of the user based on the non-payment type assessment model; and a financial product recommendation unit configured to recommend financial products based on the credit rating, wherein the first assessment factors comprise the number of SIM card activations, the number of SIM card device replacements, the number of suspensions, the number of subscription lines, and an activation period, wherein the first assessment unit generates a first assessment index using the number of SIM card activations, the number of SIM card device replacements, the number of suspensions, the number of subscription lines, and the activation period, and wherein the first assessment index is used to assess whether the user falls within the delinquent type.

The financial product recommendation unit may recommend the financial products provided by an affiliated financial company to the user.

In accordance with a fourth aspect of the present disclosure, there is provided a consultation apparatus comprising: an information collection unit configured to collect communication information of a user who has a record of communication non-payments; a first assessment unit configured to generate first assessment factors using the communication information, and to assess whether the user falls within a delinquent type using the first assessment factors; a second assessment unit configured to generate second assessment factors using the communication information, and to assess whether to fall within a user type of a high probability of voluntary payment using the second assessment factors; a third assessment unit configured to generate third assessment factors using the communication information, and to assess whether to fall within a type of user who has resolved the communication non-payments in a short period of time using the third assessment factors; a fourth assessment unit configured to generate fourth assessment factors using the communication information, and to assess whether an attitude of the user falls within a positive attitude or a negative attitude using the fourth assessment factors; a credit rating assessment unit configured to generate a non-payment type assessment model of the user using the first to fourth assessment factors, and to assess a credit rating of the user based on the non-payment type assessment model; a financial product recommendation unit configured to recommend financial products based on the credit rating of the user; and a consultation unit configured to present financial product information requested by the user based on contents of a conversation made by the user, wherein the first assessment factors comprise the number of SIM card activations, the number of SIM card device replacements, the number of suspensions, the number of subscription lines, and an activation period, wherein the first assessment unit generates a first assessment index using the number of SIM card activations, the number of SIM card device replacements, the number of suspensions, the number of subscription lines, and the activation period, and wherein the first assessment index is used to assess whether the user falls within the delinquent type.

The present disclosure has an effect of effectively assessing the credit ratings of users who have a record of non-payments by utilizing the big data of the users.

Moreover, the present disclosure has an effect of improving the quality of life of users by providing the users with appropriate financial product information.

In addition, the present disclosure has an effect of facilitating the flow of funds and realizing social value by appropriately connecting financial companies and users.

Furthermore, the present disclosure has an effect of reducing the frequency of occurrences of non-payment by users by providing the users with appropriate financial product information.

Moreover, the present disclosure has an effect of reducing complaints, management costs, and the like of customers who have a record of non-payments.

In addition, the present disclosure has an effect of attracting prospective customers and utilizing new marketing.

### BRIEF DESCRIPTION OF THE DRAWINGS

FIG. 1 is a block diagram illustrating an entire system for recommending financial products in accordance with an embodiment.

FIG. 2 is an illustration for describing second assessment index values according to second assessment factors.

FIG. 3 is an illustration for describing third assessment index values according to third assessment factors.

FIG. 4 is an illustration for describing fourth assessment index values according to fourth assessment factors.

FIG. 5 an illustration showing criteria for credit rating assessment using a non-payment type assessment model.

FIG. 6 is a diagram illustrating the operation of an entire system for recommending financial products in accordance with an embodiment.

FIG. 7 is a diagram illustrating the operation of a consultation apparatus in accordance with an embodiment.

### DETAILED DESCRIPTION

Currently, financial companies determine those who have a record of non-payments for mobile terminal bills or have not paid the current mobile terminal bill as having bad credit, thereby complete blocking them from purchasing financial products. However, for those who have a record of non-payments, there are cases in which unpaid bills are of small amounts or records of non-payments occurred even without themselves knowing. Accordingly, it is not a practical measure to completely block those with a record of non-payments from purchasing financial products.

Hereinafter, embodiments will be described in detail with reference to the drawings.

FIG. 1 is a block diagram illustrating an entire system for recommending financial products in accordance with an embodiment, FIG. 2 is an illustration for describing second assessment index values according to second assessment factors, FIG. 3 is an illustration for describing third assessment index values according to third assessment factors, and FIG. 4 is an illustration for describing fourth assessment index values according to fourth assessment factors. FIG. 5 is an illustration showing criteria for credit rating assessment using a non-payment type assessment model.

Referring to FIG. 1, a financial product recommendation system in accordance with an embodiment may comprise an apparatus 100 for providing credit assessment information.

The apparatus 100 for providing credit assessment information in accordance with the embodiment may receive communication information of a user 10 who has a record of non-payments to thereby assess the credit rating of the user 10.

The apparatus 100 for providing credit assessment information in accordance with the embodiment may comprise an information collection unit 110.

The information collection unit 110 may collect big data related to the communication of the user 10 who has a record of non-payments from a server 200 (hereinafter, referred to as “DB”). The communication information may be utilized as a basis for determining whether the user 10 falls within a good/delinquent type.

The communication information may include but is not limited to, communication data, non-payment data, and emotional data. The communication information may include but is not limited to, gender, age, terminal types, the number of lines, usage amounts, amounts of installment plans for terminals, the number of lines, payment methods, usage periods, etc. The non-payment data may include but is not limited to, information such as the number unpaid lines, unpaid total amounts, micropayments, guidance activities for non-payments, the annual number of non-payments, final payments, and the like. The emotional data may include but is not limited to, information on voices and specific words during the consultation with customers having non-payments.

Although the DB 200 is illustrated as a separate component from the apparatus 100 for providing credit assessment information, the DB 200 may be configured to be included in the apparatus 100 for providing credit assessment information.

The apparatus 100 for providing credit assessment information in accordance with the embodiment may comprise an assessment unit 120.

The assessment unit 120 may use the communication information to assess the delinquent type of the user 10, the type of user with a high probability of voluntary payment, the type of user who has resolved communication non payments in a short period of time, and the positive or negative attitude of the user 10, but is not limited thereto.

The assessment unit 120 of the embodiment may comprise a first assessment unit 121, a second assessment unit 122, a third assessment unit 123, and a fourth assessment unit 124.

The first assessment unit 121 serves to assess whether the user 10 falls within a delinquent type. The first assessment unit 121 may use the communication information to generate first assessment factors. The communication information may include information such as micropayments, voice charges, data charges, international call charges, whether a SIM card is activated alone, the number of SIM card activations, the number of SIM card device replacements, the number of suspensions, the number of subscription lines, activation periods, and so on.

The first assessment factors may include the number of SIM card activations, the number of SIM card device replacements, the number of suspensions, the number of lines of new subscription or device replacement subscription, the range of activation time, and whether the unpaid amount is exceeded.

The first assessment unit 121 may use the first assessment factors to generate a first assessment index. The first assessment index may determine that the user 10 falls within a delinquent type if the first assessment factors are lower than reference values.

For example, if the number of SIM card activations is greater than or equal to a predetermined number (two lines), the user 10 may be determined to be fallen within the delinquent type. In addition, if the number of SIM card device replacements is greater than or equal to a predetermined number (three times), the user 10 may be determined to be fallen within the delinquent type. Moreover, if the number of suspensions (illegal suspensions, shortcut suspensions, spam suspensions) is greater than or equal to a predetermined number (one time), the user may be determined to be fallen within the delinquent type. If the number of lines of new subscription or device replacement subscription is greater than or equal to a predetermined number (3 lines), the user may be determined to be fallen within the delinquent type. If a new activation period is within a predetermined range (3 months), the user may be determined to be fallen within the delinquent type. Here, it may be limited to lines with payment amounts of 200,000 Korean won or higher.

Furthermore, if the user is not a new subscriber and has an activation period exceeding a predetermined range (four months) and the unpaid amount exceeds a certain amount (200,000 Korean won), the user may be determined to be fallen within the delinquent type. Here, it may exclude lines with payments of 50,000 Korean won or higher within the last 3 months.

The second assessment unit 122 serves to assess whether to fall within a user 10 type of a high probability of voluntary payment. The second assessment unit 122 may use the communication information to generate second assessment factors.

The communication information may include non-payment related information, basic customer information, contact information, and other information. The non-payment related information may include information on the unpaid amount for the current month, the number of voluntary payments, the unpaid amount for the previous month, the number of unpaid months, and non-payment/full payment cycles. The basic customer information may include information on the average amount used in the last three months, occupation, average payment days, subscription days, usage days of the terminal, and average payment date. The contact information may include information on customers who do not have a history of consultation for non-payments for the previous year, and customers who do not have a history of consultation for the previous year. The other information may include data usage for the previous month.

As shown in FIG. 2, the second assessment factors may include at least one of assessment factor 2-1 a1, assessment factor 2-2 a2, assessment factor 2-3 a3, assessment factor 2-4 a4, and assessment factor 2-5 a5, but is not limited thereto.

The assessment factor 2-1 a1 may include the proportion of voluntary payment within the last one month out of the number of non-payments for the last 12 months, an average monthly usage amount, and subscription days. The assessment factor 2-2 a2 may include the number of non-payments for the last 12 months and the average monthly usage amount. The assessment factor 2-3 a3 may include the number of non-payments for the last 12 months and consultation for bill payments. The assessment factor 2-4 a4 may include full payment cycles for the non-payments. The assessment factor 2-5 a5 may include the number of non-payments for the last 12 months and information on whether to receive SMS notifications.

The second assessment unit 122 may use the second assessment factors to generate a second assessment index s.

The second assessment index s may be determined by Equation 1.

s=r*1/nΣₙ₌₁^{∞}(aₙ) [Equation 1]

Here, r is a weight, n is the number of the second assessment factors, and aₙ is a score of each of the second assessment factors.

The weight r may be set for the assessment factor 2-1 a1 and the assessment factor 2-4 a4 to 1, for the assessment factor 2-5 a5 to 0.8, for the assessment factor 2-3 a3 to 0.7, and for the assessment factor 2-2 a2 to 0.5. In other words, the weight r may set such that the assessment factor 2-1 a1 and the assessment factor 2-4 a4 are important assessment factors.

The third assessment unit 123 serves to assess whether to fall within a type of user who has resolved the communication non-payments in a short period of time. The third assessment unit 123 may use the communication information to generate third assessment factors. The communication information may include age, unpaid amounts, the number of non-payments, CB ratings, payment methods, usage periods, amounts of installment plans for terminals, and micropayment amounts. The third assessment unit 123 may measure recovery rates of non-payments and correlations according to age, the scale of unpaid amounts, and CB ratings.

As shown in FIG. 3, the third assessment factors may include at least one of assessment factor 3-1 b1, assessment factor 3-2 b2, assessment factor 3-3 b3, assessment factor 3-4 b4, and assessment factor 3-5 b5, but is not limited thereto.

The assessment factor 3-1 b1 may include CB rating information, information on the number of non-payments, and sample information on recovery rates of unpaid amounts. The assessment factor 3-2 b2 may include the CE rating information and payment method information. The assessment factor 3-3 b3 may include the CB rating information and information for each subscription period. The assessment factor 3-4 b4 may include the CE rating information and the presence or absence of installment plans for terminals. The assessment factor 3-5 b5 may include the CB rating information, and information on the amounts of money other than communication terminals.

The third assessment unit 123 may use the third assessment factors to generate a third assessment index y.

The third assessment index y may be determined by Equation 2.

y=r*1/nΣₙ₌₁^{∞}(bₙ) [Equation 2]

Here, r is a weight, n is the number of the third assessment factors, and bₙ is a score of each of the third assessment factors.

The weight r may be set in the order of the assessment factor 3-1 b1, the assessment factor 3-3 b3, the assessment factor 3-2 b2, the assessment factor 3-5 b5, and the assessment factor 3-4 b4.

The fourth assessment unit 124 serves to assess the attitude of the user. The fourth assessment unit 124 may use the communication information to generate fourth assessment factors. The communication information may include positive/negative voices, intonations, words, and conversation durations.

As shown in FIG. 4, the fourth assessment factors may include at least one of assessment factor 4-1 c1, assessment factor 4-2 c2, and assessment factor 4-c3, but is not limited thereto.

The assessment factor 4-1 c1 may include positive elements. The assessment factor 4-2 c2 may include negative elements. The assessment factor 4-3 c3 may include risk elements. Here, the assessment factor 4-1 c1, the assessment factor 4-2 c2, and the assessment factor 4-3 c3 may be generated using an emotion analysis system (not shown).

The fourth assessment unit 124 may use the fourth assessment factors to generate a fourth assessment index p.

The fourth assessment index p may be determined by Equation 3.

p=r*1/nΣₙ₌₁^{∞}(cₙ) [Equation 3]

Here, r is a weight, n is the number of the fourth assessment factors, and Cₙ is a score of each of the fourth assessment factors. The weight may be added as necessary, but may also be omitted.

Returning to FIG. 1, the apparatus 100 for providing credit rating information in accordance with the embodiment may comprise a credit rating assessment unit 130.

The credit rating assessment unit 130 may use the first assessment index, she second assessment index, the third assessment index, and the fourth assessment index to generate a non-payment type assessment model.

The credit rating assessment unit 130 may check whether the user falls within the delinquent type based on the first assessment index, and determine the credit rating of the user by using the sum of the second assessment index, the third assessment index, and the fourth assessment index. Here, the sum of the first assessment index, the second assessment index, the third assessment index, and the fourth assessment index may have a maximum value of 3.

If the user falls within the delinquent type based on the first assessment index, the credit rating is not assessed and therefore, the first assessment index may be set to −3. Accordingly, the sum of the second assessment index, the third assessment index, and the fourth assessment index may be 0 to 3 points.

As shown in FIG. 5, the non-payment type assessment model may be formed of a first grade, a second grade, a third grade, a fourth grade, and a fifth grade. The fourth and fifth grades of the non-payment type assessment model are grades whose credit assessment cannot be carried out due to ineligibility or lack of information.

If the sum of the first assessment index, the second assessment index, the third assessment index, and the fourth assessment index of the user is 2.8 to 3, the user can be determined as the first grade. If the sum of the first assessment index, the second assessment index, the third assessment index, and the fourth assessment index of the user is 2.6 to 2.79, the user can be determined as the second grade. If the sum of the first to fourth assessment indices of the user is 2.5 to 2.59, the user can be determined as the third grade.

Therefore, the credit rating assessment unit 130 can effectively assess the credit rating of the user based on the non-payment type assessment model.

The embodiment has an effect of effectively assessing the credit ratings of users who have a record of non-payments by utilizing the big data of the users.

Returning to FIG. 1, the financial product recommendation system in accordance with the embodiment may comprise a financial product recommendation apparatus. The financial product recommendation apparatus may comprise an apparatus 100 for providing credit assessment information and a financial product recommendation unit 600. Since the description of the apparatus 100 for providing credit assessment information is the same as described above, the detailed description thereof will not be repeated.

The financial product recommendation unit 600 may select financial products based on the credit rating of a user. The financial product recommendation unit 600 may be provided with financial products through an affiliated financial company 400. The financial product recommendation unit 600 may provide financial product information to the user through a consultation unit 500. The financial product recommendation unit 600 may access the apparatus for providing credit assessment information in real-time using an API system 300.

The financial product recommendation system in accordance with the embodiment may comprise a consultation apparatus. The consultation apparatus may comprise an apparatus 100 for providing credit assessment information, a financial product recommendation unit 600, and a consultation unit 500. Here, since the description of the apparatus 100 for providing credit assessment information and the financial product recommendation unit 600 is the same as described above, the detailed description thereof not be repeated.

The consultation unit 500 may comprise a chatbot. When a conversation with a user 10 proceeds, the consultation unit 500 can recommend financial products appropriate for the credit rating of the user 10 with the information of the user 10 through the apparatus 100 for providing credit assessment information and the financial product recommendation unit 600.

The consultation unit 500 may recommend a financial product requested by the user based on the contents of the conversation with the user out of a plurality of financial products.

If the user agrees, the consultation unit 500 may help the user to directly connect to the financial company 400 by revealing a link to the financial company. The consultation unit 500 is not limited to a chatbot, and may include a consultant.

FIG. 6 is a diagram illustrating the operation of an entire system for recommending financial products in accordance with an embodiment.

As shown in FIG. 6, if the user 10 makes an application for a financial product exclusively for communication payment (S110), the financial company 400 may request the user 10 to verify his/her identity. The user 10 can verify his/her identity to the financial company through a password or a public certificate. The financial company 400 may request a credit assessment rating from the apparatus 100 for providing credit assessment information, to thereby inquire whether or not to assess the communication payment (S120).

The apparatus 100 for providing credit assessment information performs an operation for credit rating in accordance with the embodiment. The apparatus 100 for providing credit assessment information may collect the communication information or the user from the DB 200 (S130). The apparatus 100 for providing credit assessment inform may assess the type of the user using the communication information, and may assess a credit rating based on this.

In more detail, the apparatus 100 for providing credit assessment information may generate first assessment factors using the communication information, and assess whether the user falls within a delinquent type using the first assessment factors. The apparatus 100 for providing credit assessment information may generate second assessment factors using the communication information, and assess whether to fall within a user type of a high probability of voluntary payment using the second assessment factors. The apparatus 100 for providing credit assessment information may generate third assessment factors using the communication information, and assess whether to fall within a type of user who has resolved communication non-payments in a short period of time using the third assessment factors. The apparatus 100 for providing credit assessment information may generate fourth assessment factors using the communication information, and assess whether the user falls within a positive attitude or a negative attitude using the fourth assessment factors.

The apparatus 100 for providing credit assessment information may generate a non-payment type assessment model using the first assessment factors, the second assessment factors, the third assessment factors, and the fourth assessment factors, and assess credit ratings using the non-payment type assessment model.

The operation of the apparatus 100 for providing credit assessment information is not limited to the above, and the operation may be performed based on the description in relation to FIG. 1.

The financial company 400 may receive a reply of whether qualified or not from the apparatus 100 for providing credit assessment information (S140), and reply whether to purchase the financial product to the user (S150). Under the condition that the financial product can be purchased, the user 10 may purchase the financial product through the financial company (S160). The financial company may reply, the DB 200 whether the financial product is purchased (S170).

FIG. 7 is a diagram illustrating the operation of a consul at apparatus in accordance with embodiment.

As shown in FIG. 7, if consultation is requested from the user 10 (S210), the consultation apparatus may receive credit rating assessment information from the apparatus 100 for providing credit assessment information (S220). The consultation apparatus 500 may compare the user information being consulted with the assessment system in real-time (S230). The consultation apparatus 500 may recommend the affiliated financial company 400 or provide financial product information recommended by the affiliated financial company 400 to the user (S240) based on the credit rating.

The user 10 may purchase the financial product exclusively for communication through the financial company 400 (S250). The financial company 400 may reply to the DB 200 whether the financial product is purchased (S260). Here, the DB 200 may be arranged in the apparatus 100 for providing credit assessment information.

The embodiment has an effect of improving the quality of life of users by providing the users with appropriate financial product information.

The embodiment has an effect of facilitating the flow of funds and realizing social value by appropriately connecting financial companies and users.

The embodiment has an effect of reducing the frequency of occurrences of non-payments by users by providing the users with appropriate financial product information.

The embodiment has an effect of reducing complaints, management costs, and the like of customers who have a record of non-payments.

The embodiment has an effect of attracting prospective customers and utilizing new marketing.

Although described above with reference to the drawings and embodiments, those having ordinary skill in the art will appreciate that the embodiments can be variously modified and changed without departing from the spirit of the embodiments described in the following claims.

What is claimed is:

1. An apparatus for providing credit assessment information, the apparatus comprising:
an information collection unit configured to collect communication information of a user who has a record of communication bill non-payments;
a first assessment unit configured to generate first assessment factors using the communication information, and to assess whether the user falls within a delinquent type using the first assessment factors;
a second assessment unit configured to generate second assessment factors using the communication information, and to assess whether the user falls within a user type of a high probability of voluntary payment using the second assessment factors;
a third assessment unit configured to generate third assessment factors using the communication information, and to assess whether the user falls within a type of user who has resolved the communication bill non-payments in a short period of time using the third assessment factors;
a fourth assessment unit configured to generate fourth assessment factors using the communication information, and to assess whether an attitude of the user falls within a positive attitude or a negative attitude using the fourth assessment factors; and
a credit rating assessment unit configured to generate a non-payment type assessment model of the user using the first assessment factors to the fourth assessment factors, and to assess a credit rating of the user based on the non-payment type assessment model,
wherein the first assessment factors comprise the number of SIM card activations, the number of SIM card device replacements, the number of suspensions, the number of subscription lines, and an activation period,
wherein the first assessment unit is configured to generate a first assessment index using the number of SIM card activations, the number of SIM card device replacements, the number of suspensions, the number of subscription lines, and the activation period, and
wherein the first assessment index is configured to be used to assess whether the user falls within the delinquent type.

2. The apparatus for providing credit assessment information of claim 1,
wherein the first assessment unit is configured to determine that the user falls within the delinquent type if the number of SIM card activations is greater than or equal to a predetermined number, the number of SIM card device replacements is greater than or equal to a predetermined number, the number of suspensions is greater than or equal to a predetermined number, the number of lines of new subscription or device replacement subscription is greater than or equal to a predetermined number, the activation period is within a predetermined range, or the activation period exceeds a predetermined range and an unpaid amount exceeds a predetermined amount.

3. The apparatus for providing credit assessment information of claim 1, wherein the second assessment factors comprise:
an assessment factor 2-1 using a proportion of voluntary payment within the last one month out of the number of non-payments for the last 12 months, an average monthly usage amount, and subscription days;
an assessment factor 2-2 using the number of non-payments for the last 12 months and the average monthly usage amount;
an assessment factor 2-3 using the number of non-payments for the last 12 months and consultation for bill payments;
an assessment factor 2-4 using a full payment cycle for the non-payments; and
an assessment factor 2-5 using the number of non-payments for the last 12 months and information on SMS notification reception,
wherein the second assessment unit is configured to generate a second assessment index using the assessment factor 2-1 to the assessment factor 2-5, and
wherein the second assessment index is configured to be used to assess the user type of a high probability of voluntary payment.

4. The apparatus for providing credit assessment information of claim 3, wherein the second assessment index is determined by Equation 1 below,
s=r*1/nΣₙ₌₁^{∞}(aₙ) [Equation 1]
where r is a weight, n is the number of the second assessment factors, and an is a score of each of the second assessment factors.

5. The apparatus for providing credit assessment information of claim 1, wherein the third assessment factors comprise:
an assessment factor 3-1 using CB rating information, information the number of non-payments, and sample information on a recovery rate of unpaid amounts;
an assessment factor 3-2 using the CB rating information and payment method information;
an assessment factor 3-3 using, the CB rating information and information for each subscription period;
an assessment factor 3-4 including the CE rating information and presence or absence of an installment plan of a terminal; and
an assessment factor 3-5 using the CE rating information and information on an amount of money other than a communication terminal,
wherein the third assessment unit is configured to generate a third assessment index using the assessment factor 3-1 to the assessment factor 3-5, and
wherein the third assessment index is configured to be used to assess the type of user who has resolved the communication bill non-payments in a short period of time.

6. The apparatus for providing credit assessment information of claim 5, wherein the third assessment index is configured to be determined by Equation 2 below,
y=r*1/nΣₙ₌₁^{∞}(bₙ) [Equation 2]
where r is a weight, n is the number of the third assessment factors, and bn is a score of each of the third assessment factors.

7. The apparatus for providing credit assessment information of claim 1, wherein the fourth assessment factors comprise:
an assessment factor 4-1 including positive elements;
an assessment factor 4-2 including negative elements; and
an assessment factor 4-3 including risk elements,
wherein the fourth assessment unit is configured to generate a fourth assessment index using the assessment factor 4-1 to the assessment factor, and
wherein the fourth assessment index is configured to be used to assess the positive attitude or the negative attitude of the user.

8. The apparatus for providing credit assessment information of claim 7, wherein the assessment factor 4-1 is configured to use information on a will to collect, payment methods, deadlines, date inquiries, changes in voice tone, and short talk time, for assessment,
wherein the assessment factor 4-2 is configured to use information extensions of non-payments, inquiries on alternative methods, non-payment extensions, loss of contact, changes in voice tone, and long talk time, for assessment, and
wherein the assessment factor 4-3 is configured to use information on abusive language, swear words, slang, long talk time, and reports, for assessment.

9. The apparatus for providing credit assessment information of claim 8, wherein the fourth assessment index is configured to be determined by Equation 3 below,
p=r*1/nΣₙ₌₁^{∞}(cₙ) [Equation 3]
where r is a weight, n is the number of the fourth assessment factors, and Cn is a score of each of the fourth assessment factor.

10. The apparatus for providing credit assessment information of claim 1, wherein the non-payment type model is configured to be formed by summing up values of the second to fourth assessment indices assessed by the second to fourth assessment units based on the first assessment index assessed by the first assessment unit, and by classifying the credit rating the user into first to third grades based on the summed value.

11. A method for providing credit assessment information performed by an apparatus for providing credit assessment information, the method comprising:
collecting communication information of a user who has a record of communication bill non-payments by an information collection unit of the apparatus;
generating first assessment factors using the communication information, and assessing whether the user falls within a delinquent type using the first assessment factors by a first assessment unit of the apparatus;
generating second assessment factors using the communication information, and assessing whether the user falls within a user type of a high probability of voluntary payment using the second assessment factors by a second assessment unit of the apparatus;
generating third assessment factors using the communication information, and assessing whether the user falls within a type of user who has resolved the communication bill non-payments in a short period of time using the third assessment factors be a third assessment unit of the apparatus;
generating fourth assessment factors using the communication information, and assessing whether the user falls within a positive attitude or a negative attitude using the fourth assessment factors by a fourth assessment unit of the apparatus for providing credit assessment information; and
generating a non-payment type assessment model of the user using the first to fourth assessment factors, and assessing a credit rating based on the non-payment type assessment model by a credit rating assessment unit of the apparatus;
wherein in assessing whether the user falls within a delinquent type using the first assessment factors,
the first assessment factors comprise the number of SIM card activations, the number of SIM card device replacements, the number of suspensions, the number of subscription lines, and an activation period,
the first assessment unit generates a first assessment index using the number of SIM card activations, the number of SIM card device replacements, the number of suspensions, the number of subscription lines, and the activation period, and
the first assessment index is used to assess whether the user falls within the delinquent type.

12. A financial product recommendation apparatus comprising:
an information collection unit configured to collect communication information of a user who has a record of communication bill non-payments;
a first assessment unit configured to generate first assessment factors using the communication information, and to assess whether the user falls within a delinquent type using the first assessment factors;
a second assessment unit configured to generate second assessment factors using the communication information, and to assess whether the user falls within a user type of a high probability of voluntary payment using the second assessment factors;
a third assessment unit configured to generate third assessment factors using the communication information, and to assess whether the user falls within a type of user who has resolved the communication bill non-payments in a short period of time using the third assessment factors;
a fourth assessment unit configured to generate fourth assessment factors using the communication information, and to assess whether an attitude of the user falls within a positive attitude or a negative attitude using the fourth assessment factors;
a credit rating assessment unit configured to generate a non-payment type assessment model of the user using the first to fourth assessment factors, and to assess a credit rating of the user based on the non-payment type assessment model; and
a financial product recommendation unit configured to recommend financial products based on the credit rating,
wherein the first assessment factors comprise the number of SIM card activations, the number of card device replacements, the number of suspensions, the number of subscription lines, and an activation period,
wherein the first assessment unit is configured to generate a first assessment index using the number of SIM card activations, the number of SIM card device replacements, the number of suspensions, the number of subscription lines, and the activation period, and
wherein the first assessment index is configured to be used to assess whether the user falls within the delinquent type.

13. The financial product recommendation apparatus of claim 12, wherein the financial product recommendation unit is configured to recommend the financial products provided by an affiliated financial company to the user.

14. A consultation apparatus comprising:
an information collection unit configured to collect communication information of a user who has a record of communication bill non-payments;
a first assessment unit configured to generate first assessment factors using the communication information, and to assess whether the user falls within a delinquent type using the first assessment factors;
a second assessment unit configured to generate second assessment factors using the communication information, and to assess whether the user falls within a user type of a high probability of voluntary payment using the second assessment factors;
a third assessment unit configured to generate third assessment factors using the communication information, and to assess whether the user falls within a type of user who has resolved the communication bill non-payments in a short period of time using the third assessment factors;
a fourth assessment unit configured to generate fourth assessment factors using the communication information, and to assess whether an attitude of the user falls within a positive attitude or a negative attitude using the fourth assessment factors;
a credit rating assessment unit configured to generate a non-payment type assessment model of the user using the first to fourth assessment factors, and to assess a credit rating of the user based on the non-payment type assessment model;
a financial product recommendation unit configured to recommend financial products based on the credit rating of the user; and
a consultation unit configured to present financial product information requested by the user based on contents of a conversation made by the user,
wherein the first assessment factors comprise the number of SIM card activations, the number of SIM card device replacements, the number of suspensions, the number of subscription lines, and an activation period,
wherein the first assessment unit is configured to generate a first assessment index using the number of SIM card activations, the number of SIM card device replacements, the number of suspensions, the number of subscription lines, and the activation period, and
wherein the first assessment index is configured to be used to assess whether the user falls within the delinquent type.
